(19) United States
(12) Patent Application Publication
(10) Pub. No.: US 2006/0060217 A1
(43) Pub. Date: Mar. 23, 2006

(54) Wash system employing snow blast

(76) Inventor: David E. Wilsey, Quakertown, PA (US)

Correspondence Address: Michael de Angeli;MICHAEL M. DE ANGELI, P.C., 60 INTREPID LANE, JAMESTOWN, RI, 02835, US

(21) Appl. No.: 11/220,418

(22) Filed: Sep. 7, 2005

Related U.S. Application Data
(60) Provisional application No. 60/607,482, filed on Sep. 7, 2004.

(51) Int. Cl. B08B 7/04; B08B 3/00

(52) U.S. Cl. 134/18; 134/123; 134/34

(57) ABSTRACT

A high-velocity plume of snow produced by mixing streams of a compressed medium, e.g., chilled compressed air and/or liquid nitrogen, and cold water is used as a washing stream, e.g., as a replacement for mechanical scrubbing elements in a car wash. A microprocessor monitors the relevant conditions in the car wash tunnel, e.g., the temperature, barometric pressure, and humidity, and controls the temperature and pressure of streams of water and compressed medium to ensure efficient production of snow; nucleating particles, detergent, and/or wax can also be supplied if necessary. In one preferred embodiment, a plurality of snow guns are mounted on posts extending up either side of and across the top of the wash tunnel, so as to reliably blast each square inch of the vehicle's surface. The posts may serve as manifolds for water, air, or both, and may be reciprocated along their axes and also rotated back and forth, to ensure full coverage. Preferably the water is recovered and used to chill the compressed air, which may also be fully or partially recovered. A cleansing snow blast produced according to the invention can be provided by a portable device.

### CROSS-REFERENCE TO RELATED APPLICATION

This application claims priority from Provisional Application Ser. 60/607,482, filed Sep. 7, 2004.

### FIELD OF THE INVENTION

This invention relates to using snow, that is, a high-velocity plume of water crystallized as snow, manufactured on site by mixing a stream of water with pressurized, chilled air and or/nitrogen or another gas as a scrubbing element in vehicle wash systems, in lieu of brushes, dangling strips of plastic foam, and the like. The same technique can be used in other washing applications.

### BACKGROUND OF THE INVENTION

In the typical vehicle wash system (hereinafter sometimes “car wash”) the vehicle is drawn through a wash tunnel having a sequence of stations at which various steps in the process are performed. Typically, at a first station warm soapy water is sprayed onto the vehicle; then fibrous brushes of various types, dangling strips of plastic, or other physical objects are rubbed against the vehicle to scrub and loosen the soil; then the vehicle is rinsed again, and is finally dried by high pressure air. Other steps, such as application of spray wax, and specialized undercarriage and wheel cleaning treatments, are of course also commonly employed.

The present invention is based on the observation by the inventor that the side of his car that was exposed to a blizzard one evening was completely cleaned by the blown snow, even though the remainder of the car was filthy due to melted snow, salt and the like. The same observation was made on another night as to the opposite side of the car. These observations led the inventor to think that the scrubbing step of conventional carwashes might usefully be replaced by a snow-spraying step, and that this might have substantial advantages.

Specifically, a problem with rotating brushes and foam strips and the like used as scrubbing devices is that they cannot well accomodate vehicles of varying size and those with protruding accessories and the like. For example, roof racks, rear-view mirrors and radio antennas are often damaged by such scrubbing devices. Furthermore, many larger vehicles such as SUVs, RVs, and of course trucks cannot be accomodated in standard carwashes. Moreover, even if a wash system were sized suitably to accomodate such larger vehicles, the problem of damage to protruding accessories would remain. Still further, use of such mechanical scrubbing devices is thought by many persons inevitably to involve some scratching of the car's paint, and many refuse to use such car washes for that reason.

Employment of a snow blast as the scrubbing element, that is, in lieu of brushes or plastic strips or the like, would avoid many of these problems. The snow blast would not need to touch the car, so there would be no problem with protruding objects. Similarly, the wash tunnel could easily be sized to suit the vast majority of vehicles, since mechanical contact would be avoided. For the same reason, the problem of scratched paint could be eliminated. Possibly a savings in construction or operation cost could also be realized (although as of the filing of this application this possibility has not been fully investigated).

The art has suggested that “matter which is capable of being changable in its state or phase such as water, is used in a solid phase”, specifically as shaved ice, for cleaning cars. See Courts patent 2,699,403. However, as will appear below, the present invention involves numerous advantages over the basic concept shown by Courts. Various patents, including Miyahara 4,977,910, Palombo 5,637,027, Bowen et al 5,853,128 and Borden 6,066,032, show using liquid or frozen carbon dioxide for various cleaning purposes. Dye patent 2,536,843 shows adding soft pellets to the water stream in a car wash.

The art also shows equipment and techniques for the artifical manufacture of snow, which, broadly speaking, could be used in implementation of the present invention. See, e.g., www.snowmakers.com, or www.arecosnow.com. However, the inventor is unaware of any reference specifically suggesting the combination of known snowmaking equipment and known car washing techniques, including the Courts patent.

### SUMMARY OF THE INVENTION

According to the present invention, blasts of snow produced by mixing streams of cold compressed air or another compressed medium, for example, liquid nitrogen, and cold water are used as a cleansing spray. A plurality of such sprays could be arranged as the scrubbing element in a car wash, or a single spray can be provided on a wand, as in a conventional pressure washing system. More specifically, a high-velocity plume of water crystallized as snow, perhaps with some unfrozen water mixed therewith, to carry away the dislodged soil, and possibly also with a liquid or micro-granular detergent is sprayed against a vehicle or any other object to be washed.

In the car wash embodiment, a microprocessor monitors the relevant conditions in the car wash tunnel, e.g. the temperature, barometric pressure, and humidity, and controls the temperature and pressure of streams of water and air to ensure efficient production of snow of suitable characteristics for cleaning without abrasion. Nucleating particles can also be supplied if necessary. In one preferred embodiment, a plurality of snow guns are mounted on posts extending up either side of and across the top of the wash tunnel, so as to reliably blast each square inch of the vehicle's surface. The posts may serve as manifolds for water, air, or both, and may be reciprocated along their axes and also rotated back and forth, to ensure full coverage. If chilled compressed air is used, preferably the water is recovered and used to chill the compressed air, which may also be fully or partially recovered.

As noted, the principles of the invention could also be used to provide a portable device, comparable to existing pressure washing equipment, that would provide a blast of snow instead of high-pressure water, as a cleaning stream.

### BRIEF DESCRIPTION OF THE DRAWINGS

The invention will be better understood if reference is made to the accompanying drawings, in which:

FIG. 1 shows a schematic perspective view of a car wash tunnel according to the invention, with a schematic diagram of the principal components of the snow blast system;

FIG. 2 shows a partially cut-away perspective, and FIG. 3 a cross-sectional view of one of the snow guns according to the invention;

FIG. 4 shows one embodiment of a mechanism for oscillating and reciprocating the air and water supply manifold assembly;

FIG. 5 shows a detail of the FIG. 4 mechanism;

FIG. 6 shows schematically a portable device incorporating the teachings of the invention; and

FIG. 7 shows an alternative construction for a snow nozzle.

### DESCRIPTION OF THE PREFERRED EMBODIMENTS

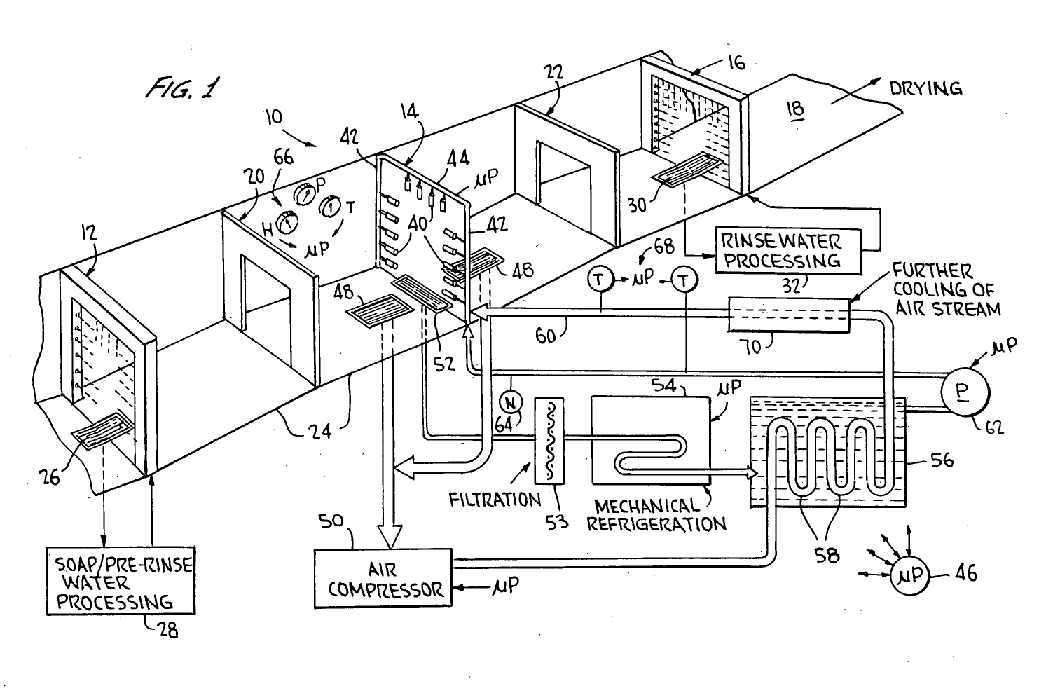

As mentioned, FIG. 1 shows a schematic perspective view of a car wash tunnel 10 according to the invention, shown with the near wall and roof removed, and with a schematic diagram of the principal components of the snow blast system. Vehicles (not shown) pass through the wash tunnel from left to right in the diagram. The car wash system includes an initial rinse station 12, at which the vehicle is blasted with warm soapy water, to loosen and remove as much surface soil as possible; a scrubbing station 14, at which the conventional brushes, foam strips or the like are replaced by blasts of snow according to the invention, and remove substantially all soil; a second post rinse station 16, where the vehicle is again sprayed with water; and a drying station, indicated at 18, where the vehicle is dried by blasts of air.

As indicated, the initial rinse station 12, the final rinse station 16, and the drying station 18 are generally conventional, but their implementation may be optimized in a car wash system incorporating the snow blast scrubbing technique of the invention. For example, in order to save on the energy costs of producing snow, particularly in warmer weather, it is desirable to reclaim as much of the cold air used as possible, so that the scrubbing station 14 is separated from the rinse stations 12 and 16 by baffles 20 and 22 respectively. It is also desirable to process the rinse water streams separately from the water stream resulting as the snow melts, so that the floor of the wash tunnel is sloped separately at each station, as indicated at 24, and separate drains are provided at each station. Thus, the soap and prerinse water stream is collected at a drain 26 and processed for reuse, at 28, and the post rinse water is similarly collected at a drain 30 and processed for reuse at 32.

Turning now to the specific improvements provided according to the invention, as noted at the scrubbing station 14 the vehicle is blasted by sprays of snow from a number of snow guns 40 rather than being mechanically scrubbed by brushes, foam strips or like devices. As illustrated, preferably the snow guns are arranged at least along vertical supports 42 extending up either side of the wash tunnel, and along a horizontal support 44 extending across the wash tunnel 10; similar snow guns could also be arranged to spray the undercarriage of the vehicle. It is considered to be within the invention and the skill of the art to provide adjustable spacing of the supports 42 and 44 responsive to the size of the vehicle, so that the snow guns could be spaced an optimum distance from the surfaces of vehicles of substantially varying overall dimensions, so that the snow spray impacting the vehicle would be of optimum condition and density. For example, it would be comparatively straightforward to provide the attendant with an adjustable mechanical device to be brought to within a given distance from one flank and the roof of each vehicle as it enters the tunnel 10, and to then press an “Enter” button or the like, so as to record the dimensions. When the vehicle subsequently reaches the scrubbing station 14, the supports 42 and 44 could be moved accordingly, under control of a microprocessor (“μP”) 46.

As indicated throughout FIG. 1 by the symbol “μP”, microprocessor 46 controls many aspects of the operation of the snow gun scrubbing station 14 according to the invention. These are discussed further below. Briefly, the microprocessor 46 monitors the temperature, barometric pressure, and humidity within the wash tunnel in the vicinity of the scrubbing station 14, and adjusts the temperature and pressure of the incoming water and air streams so as to ensure that snow of the correct consistency is provided as the scrubbing spray.

It should be understood that reference to “compressed air” herein is to be read (where the context does not clearly exclude doing so) to include reference to additional compressed media that would also suffice to produce a spray of snow if mixed with a stream of water under the appropriate conditions. The use of liquid nitrogen for this purpose is discussed further below. The compressed media used to form snow when mixed with a stream of water could also include compressed or liquid air, as well as liquid or compressed nitrogen, and combinations of these and other suitable media. Further, reference to a pressurized, high-velocity stream or plume of snow should be understood to possibly include unfrozen water (possibly useful to carry off the loosened soil), detergents, wax, and the like.

As will be apparent to those of skill in the art, manufacture of snow demands production of sprays of water and chilled air (or another compressed medium, as above); if a spray of water is mixed with one of air under the correct conditions, a stream of snow is produced. Snowmaking as practiced in ski resorts is normally only undertaken when the weather is suitable, i.e., the air temperature is below 32° F., so that only the water needs to be cooled to the freezing point. However, in order that a car wash employing snow as the scrubbing agent can operate year-round, it will be necessary to chill both water and air. In order to reduce the cost of operation as much as possible, it is important to provide the streams of cold water and air as efficiently as possible. FIG. 1 shows several expedients that may prove useful in this effort.

For example, to the extent it is possible to keep reusing previously chilled air, the energy cost involved in cooling warmer ambient air can be eliminated or reduced. (It is not anticipated that it will be practical to thus reclaim liquid nitrogen if used as the medium.) Accordingly, cool air returns 48 are provided in the floor of the scrubbing section 14 of the wash tunnel 10, and baffles 20 and 22 are provided to separate this area from the remainder of the tunnel and the outside air. That is, although it will probably be impractical to completely segregate the atmosphere of the scrubbing section 14, baffles 20 and 22 can be expected to limit the influx of warmer ambient air to some extent. Streams of air, as practiced in markets to keep fresh food chilled while permitting free access thereto, might also be employed to separate the several areas of the wash tunnel.

Air collected by returns 48 is dried and filtered as necessary by conventional equipment, not shown, and then compressed in air compressor 50. Compressing the air warms it, of course, so it must be cooled again before reuse in snow guns 40. In one possible embodiment, cooling of the air can be at least partially accomplished by heat exchange with the water also recovered from the scrubbing section 14. That is, snow ejected from snow guns 40 will melt as it hits the vehicle, and the water resulting is collected in a floor drain 52. It is then filtered at 52, cooled by mechanical refrigeration unit 54, and supplied to chilled-water tank 56 for storage. Air from compressor 50 is ducted through serpentine ducts 58 disposed in tank 56, whereby the air is chilled. The chilled air is then supplied again to snow guns 40, as indicated by arrow 60; similarly, pump 62 forces water from tank 56 to the snow guns 40.

As is well known, the formation of snowflakes can be hastened by the introduction of a particulate material into either of the water or air streams; the particulate can be dust, smoke, pollen, or the like. In this context it must obviously not be an abrasive material. To this end a nucleator is shown being introduced into the water stream at 64.

As mentioned above, a microprocessor 46 (using this term to refer generically to programmable controller devices of all types, including personal computer-based systems) controls the parameters according to which the streams of air and water (and nucleator, if used) are introduced into the scrubbing station 14 to ensure efficient production of snow. To this end, the temperature, barometric pressure, and humidity in the scrubbing station 14 are monitored, as indicated at 66. Similarly, the temperature of the water and air streams can be monitored at one or more locations, as indicated at 68. Variables controlled in accordance with this information and stored data defining the optimal snowmaking conditions include the pressure and temperature of the compressed nitrogen or other media, if used; the air pressure, controlled by operation of compressor 50; the water temperature, controlled by operation of mechanical refrigeration unit 54; the water pressure, controlled by operation of pump 62; and the air temperature, controlled by residence time in the heat exchange coils 58, and thus being a function of the water temperature and air pressure as well. Due to this complex relationship additional cooling of the air stream, indicated at 70, may be desirable. Of course, the flow rates of the water and nitrogen and/or air streams could be monitored and controlled in addition to, or in lieu of, the pressures thereof.

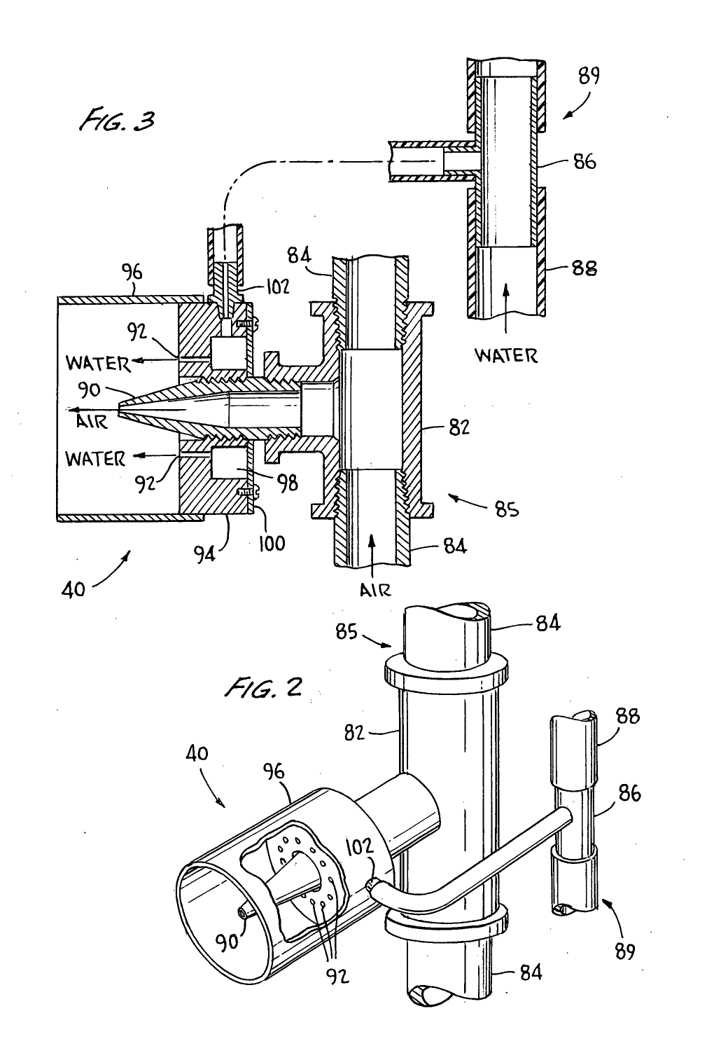

Some degree of experimentation can be expected to be required in order to determine the optimal characteristics of the snow required to scrub soil from vehicles, and then to arrive at the most efficient parameters for the air and water streams used to produce the snow; such experimentation is clearly within the skill of the art. It will be appreciated that as cooling of the air and water streams will occur as they are sprayed into the scrubbing chamber, due to their expansion from a pressurized condition to atmospheric pressure, they will presumably both need to be cooled to slightly above 32° F. Similarly, a wide variety of possible designs for the snow guns and related apparatus will occur to those of skill in the art. One possible embodiment of these will now be discussed with respect to FIGS. 2-5. Again, experimentation concerning and optimization of these constituents of a system according to the invention is considered to be within the skill of the art, and various embodiments not shown specifically herein to be within the scope of the invention.

FIGS. 2 and 3 show respectively cross-sectional and perspective views of a single snow gun assembly 40 designed so as to be readily connected in series, so that a number of such assemblies 40 can conveniently be provided on either side of the scrubbing station 14 and across its top, as illustrated in FIG. 1. In this embodiment, a number of snow gun assemblies are connected to “tee” fittings 82 connected by lengths of pipe 84, so that the construction 85 forms both support structure for the snow guns 40 and a manifold for, in the configuration shown, chilled compressed air. Water, chilled and under pressure, is supplied to the snow guns 40 by way of a similar construction 89 comprising lengths 88 of pipe or tubing connected by tee fittings 86.

As illustrated, the air exits the snow gun 40 by way of a nozzle 90, while the water exits from an annular ring of orifices 92 drilled in a body 94. The nozzle 90 and annular ring of orifices 92 are surrounded by a tubular member 96 defining a mixing chamber, which may be of assistance in ensuring good mixing of the water and air streams and thus efficient snowmaking. Of course numerous options for ensuring good mixing will occur to those of skill in the art; for example, the water jets exiting the orifices 92 might be directed at angles so as to intersect the air stream. The simple cylindrical shape of the member 96 might be replaced by a converging cone, so that the air and water streams would have to pass through a single orifice some distance from the exit of nozzle 90. The positions of the air and water streams could be exchanged, i.e., so that the water stream is emitted from the central nozzle of the gun, and the air from the surrounding orifices. Additional annular rings of water and air nozzles might be useful. Other subjects for experimentation and optimization are within the skill of the art and the scope of the invention. Similarly, the snowmaking industry, although directed primarily to snowmaking for ski slopes, may have information useful in the car wash context, and the teachings of that art are incorporated herein by reference.

The snow gun 40 is shown as being assembled by threading the body 94 over the nozzle 90, which in turn is threaded to the tee fitting 82. The orifices 92 communicate with an internal manifold 98, to provide adequate flow, which could be machined into the body and then sealed off by backing plate 100. Water is supplied via a fitting 102 threaded into body 94 and communicating with manifold 98. Again, numerous variations and improvements on this structure will occur to those of skill in the art, and may prove useful after experimentation. For example, it might be quite satisfactory to form the orifices for water jets by assembling a number of small fine-spray nozzles to a tube formed into a ring and surrounding a relatively large air duct, all disposed within a mixing tunnel. As noted above, possibly it would be useful to have the water streams in the center of the snow gun, and be surrounded by air streams; or several annular streams of both might be best. Such variations and modifications are considered within the scope of the invention.

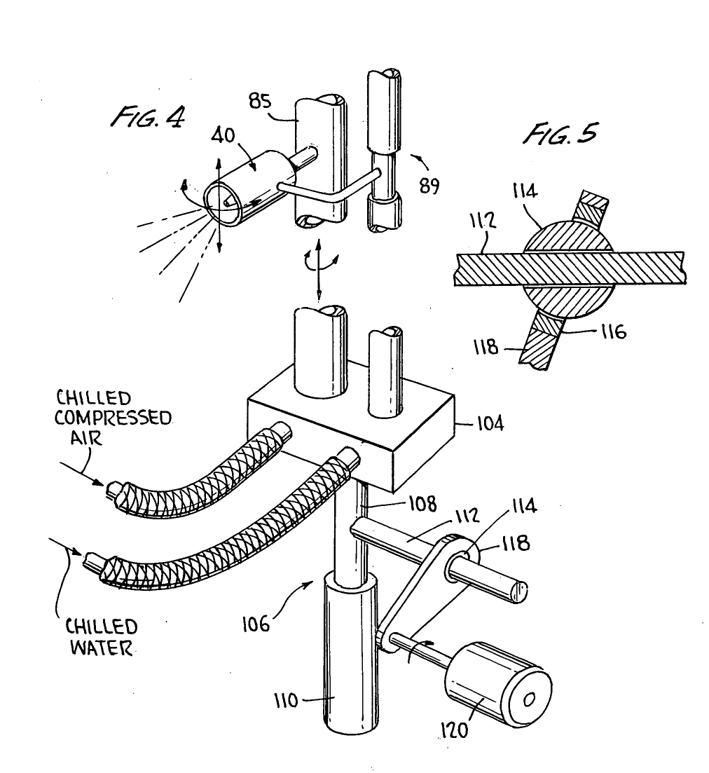

FIG. 4, a detail of which forms FIG. 5, shows a simple mechanism for reciprocating the assembly of snow guns with support structure also providing air and water manifolds, while also rotating the assembly back and forth through an arc, so as to ensure that the snow stream impacts the entire surface of the vehicle being washed. In this embodiment, the assemblies of snow guns 40 and their supporting tubular manifolds 85 and 89 are supported at a base 104, at which the manifolds are connected to supplies of chilled water and chilled compressed air by flexible tubing. Base 104 is supported so that it can be lifted and rotated, as indicated generally at 106. More specifically, a cylindrical rod member 108 fixed to base 104 slides within a tubular bearing member 110; typically a similar structure would be provided at the upper end of a vertical assembly of this kind, and at both ends of a horizontally-mounted assembly. A rigid arm 112 is fixed to rod member 108, and passes through a spherical ball bushing member 114 (see FIG. 5) confined within a correspondingly-shaped race 116 in turn fixed to a crank throw 118 rotated by a motor 120. Accordingly, the angle between arm 112 and crank throw 118 is allowed to vary, due to the provision of spherical bushing 114 therebetween. Further, the fit between the bore in spherical bushing 114 and arm 112 is such that arm 112 can slide freely back and forth through the bore and rotate therein. Thus, as crank throw 118 is rotated by motor 120, arm 112 is driven so as to raise and lower rod 108 while rotating it back and forth through an arc; this motion is translated to base 104, thence to manifolds 85 and 80, and thus to snow guns 40, ensuring good variation in the direction of spraying and thus good scrubbing of the vehicle to be cleaned.

It will be apparent that numerous other mechanisms could be provided for accomplishing the same or better results; perhaps the most likely embodiment to occur to those of skill in the art would be to provide hydraulic or pneumatic actuation of a mechanism moving the snow guns to ensure good coverage. Another possibility would be to articulate the snow guns with respect to the support structure, connecting the guns to the water and air manifolds with flexible hoses, so that the mass of the support structure would not need to be moved with the guns.

As mentioned above, it is within the scope of the invention to employ a stream of a compressed medium other than or in addition to compressed air to cooperate with a stream of water to form snow. Compressed nitrogen is one possible choice for this alternative medium.

More specifically, nitrogen is widely and relatively inexpensively available, as a gas at 3000 psi in heavy cylinders or as a liquid in Dewar vessels at low temperature and relatively lower pressure. In either case, the nitrogen is supplied under high pressure, so that as it is released into the atmosphere, it will expand and be rapidly cooled; if the water stream is efficiently mixed with the nitrogen as it expands, a stream of snow will be produced, which could be used in accordance with the principles of the invention, as above, as a washing stream. Employment of liquid nitrogen instead of, or in addition to, compressed and cooled air as the medium to be mixed with water to form a blast of snow might well be economically preferable, as it could eliminate or reduce the cost of chilling and compressing equipment. As above, experimentation to determine workable and optimal conditions to form snow of the preferred consistency is considered to be within the skill of the art. As mentioned above, in a vehicle wash system employing liquid nitrogen as the medium it is not expected to be feasible to reclaim the nitrogen for reuse, as might be possible with compressed air.

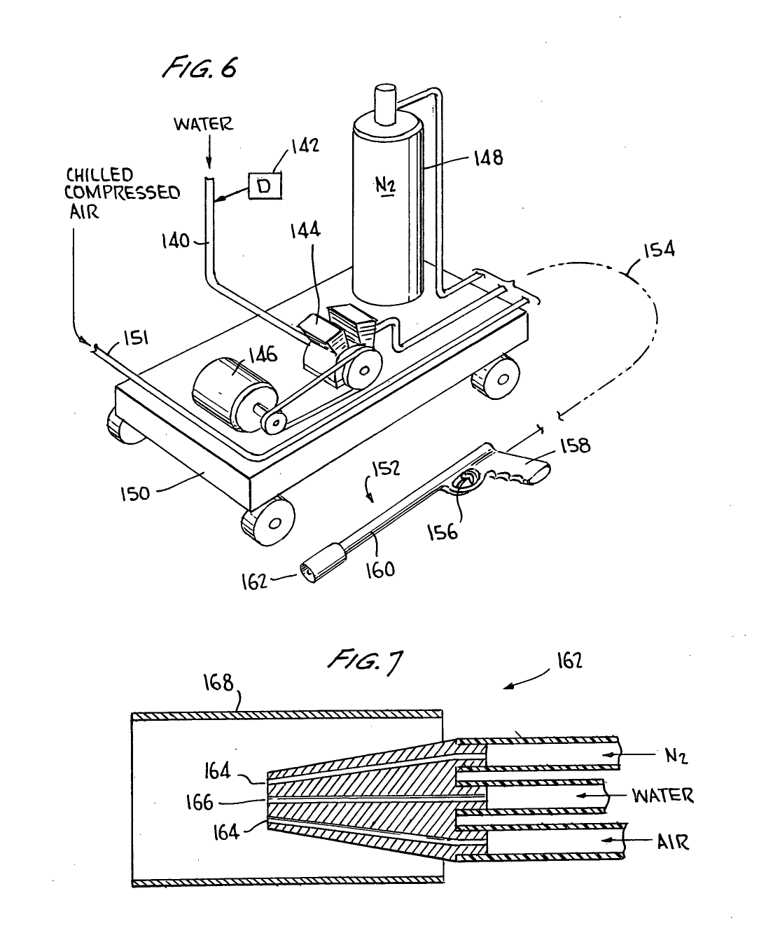

It is also within the scope of the invention to employ the principles thereof in a portable device, comparable in size, for example, to existing pressure washing equipment. Such equipment would comprise a high-pressure water pump, adapted to be connected to a water line, possibly with addition of a detergent, a source of compressed chilled air, and/or another medium suitable for forming snow when mixed with water, e.g., liquid nitrogen, as above, and a mixing nozzle. These components, together with the required hoses, valves, power connection for the pump, and the like, could readily be mounted on a wheeled cart for convenience. See FIG. 6. As illustrated, a supply of water, indicated at 140, with detergent optionally added at 142, is connected to a high-pressure pump 144, driven by a motor 146. These components, together with a tank of liquid nitrogen 148, are mounted on a cart 150 for convenient movement. If desired, a connection made be provided to a stream of chilled compressed air, as above, as indicated at 151. The nitrogen from tank 148, compressed air if used, and high-pressure stream of water are supplied to a cleansing gun 152 by flexible hoses 154. Gun 152 comprises a control trigger 156, a gripping handle 158, a wand 160, and a nozzle assembly 162.

FIG. 7 provides a cross-sectional view of one possible embodiment of such a nozzle assembly 162; in this design, the nozzle is akin to those used for oxyacetylene torches, with the medium, again perhaps liquid nitrogen and/or compressed air emitted from a number of apertures 164 disposed in an annular arrangement around a central nozzle 166 emitting the stream of water. As the liquid nitrogen and/or air reach atmospheric pressure, it will be rapidly cooled, and, if properly mixed with the water stream, will cause a stream of snow to be formed. A tubular guard 168 may be useful in controlling the mixing conditions to optimize snow formation. Again, some experimentation will be necessary to optimize the formation of an effective stream of snow; this experimentation is believed to be within the skill of the art. One area to be explored would be variation of the axial spacing of the nozzles for the water and medium; in using liquid nitrogen as the medium, that is, where the cooling of the nitrogen which occurs as its pressure is reduced to ambient, is employed to cool the water stream to form snow as the water exits the nozzle, it would be important to avoid ice build-up from condensation on the nozzle surfaces, to prevent clogging.

As noted above, the high-velocity plume of snow provided as a cleansing agent according to the invention may include water crystallized as snow, unfrozen liquid water, and a detergent. It is also within the scope of the invention to include a liquid or micro-granular wax to the plume of snow produced according to the invention.

While a preferred and several alternative embodiments have been described, the invention is not to be limited thereto.

What is claimed is:

1. A vehicle wash system, comprising in sequence:
a prewash station;
a scrubbing station;
a post rinse station;
and a drying station;
wherein said scrubbing station comprises (a) a plurality of snow guns mounted so as to spray snow at substantially all exterior surfaces of vehicles to be washed, (b) means for supplying streams of pressurized water and a compressed medium to said snow guns for being mixed to form snow, and (c) a controller for controlling the parameters at which said streams are supplied to said snow guns so as to ensure that snow is efficiently produced.

2. The wash system of claim 1, wherein said controller is responsive to the temperature, atmospheric pressure, and humidity at said scrubbing station and controls said parameters at which said streams are supplied to said snow guns responsive thereto.

3. The wash system of claim 1, further comprising drains for collecting melted snow as water, filters for cleaning the collected water, and means for pressurizing the collected cleaned water for reuse.

4. The wash system of claim 1, further comprising means for collecting pre- and post-rinse water separately and processing it for reuse.

5. The wash system of claim 1, wherein the compressed medium mixed with the stream of water to form snow is a gas selected from the group consisting of nitrogen and air.

6. The wash system of claim 1, wherein the compressed medium mixed with the stream of water to form snow is one or both of compressed air and liquid nitrogen.

7. The wash system of claim 6, wherein the stations of said wash system are enclosed in a tunnel comprising return ducts for collecting cold air for reuse.

8. The wash system of claim 6, wherein said compressed air is chilled by heat exchange with melted snow recovered as water.

9. The wash system of claim 1, wherein said snow is formed by introduction of streams of water and said compressed medium to coaxial apertures comprised by said snow guns.

10. The wash system of claim 9, wherein said stream of water is introduced into a central nozzle and said compressed medium to a annular ring of nozzles surrounding said central nozzle.

11. The wash system of claim 9, wherein said compressed medium is introduced into a central nozzle and said to a annular ring stream of water of nozzles surrounding said central nozzle.

12. The wash system of claim 1, wherein a plurality of said snow guns are mounted on articulated support structures, arranged to be driven so that said snow guns are oscillated and/or reciprocated in order to scrub the entire surface of a vehicle passing thereby.

13. The wash system of claim 1, wherein the articulated support structures also comprise manifolds for supplying said streams of water and compressed medium to said snow guns.

14. A method for employing snow sprays as scrubbing elements in wash systems, comprising the steps of:
providing streams of compressed medium and pressurized water to at least one snow gun, said gun comprising a mixing nozzle assembly for mixing the streams of medium and water, and controlling the temperature and pressure of said streams so as to ensure efficient production of sprays of snow of desired qualities by said snow gun; and
directing said spray of snow onto objects to be washed.

15. The method of claim 14, wherein said method is employed for washing vehicles in a wash tunnel, and comprising the further steps of: monitoring ambient conditions of temperature, pressure, and humidity within a scrubbing station in said wash tunnel, and controlling the parameters under which said streams are supplied to said guns in accordance with said monitored conditions.

16. The method of claim 15, comprising the further step of collecting melted snow water for reuse.

17. The method of claim 15, wherein compressed air is used as the medium, and comprising the further step of collecting chilled air for reuse.

18. The method of claim 14, wherein liquid nitrogen is used as the medium.

20. A portable device for washing of objects, comprising:
a pump for being connected to a supply of water and producing a high-pressure stream of water;
a source of a stream of a compressed medium; and
a nozzle assembly connected to said streams of water and medium for mixing said streams so as to produce a stream of snow.

21. The device of claim 20, further comprising flexible hoses connecting said nozzle assembly to said streams.

22. The device of claim 20, wherein the medium is liquid nitrogen.

23. The device of claim 22, wherein a tank of liquid nitrogen is mounted on a cart together with said pump.
